(19) United States
(12) Patent Application Publication
(10) Pub. No.: US 2008/0278374 A1
(43) Pub. Date: Nov. 13, 2008

(54) Method For Dynamically Selecting Antenna Array Architecture

(75) Inventors: Tiezhu Xu, Shanghai (CN); Feng Li, Shanghai (CN); Shaoli Kang, Shanghai (CN)

Correspondence Address: FOLEY AND LARDNER LLP;SUITE 500, 3000 K STREET NW, WASHINGTON, DC, 20007, US

(73) Assignee: Shanghai Ultimate Power Communications Technology Co., Ltd.

(21) Appl. No.: 11/913,775

(22) PCT Filed: Apr. 26, 2006
(86) PCT No.: PCT/CN06/00793

§ 371 Date: Apr. 10, 2008

(30) Foreign Application Priority Data
May 9, 2005 (CN) 200510069458.3

(51) Int. Cl. H01Q 25/00; H04B 1/06; H01Q 21/29

(52) U.S. Cl. 342/378; 342/383

(57) ABSTRACT

The present invention discloses a method for dynamically selecting antenna array architecture, deciding a basic antenna array, determining a number of required array elements, selecting determined number of array elements from all the array elements in the basic antenna array to form an antenna array architecture and receiving and detecting signals with the current antenna array architecture, the method further including: determining whether transmission time intervals and/or slot positions of received signals change, if so, re-selecting the determined number of array elements from all the array elements in the basic antenna array to form a new antenna array architecture and receiving and detecting signals with the new antenna array architecture, otherwise, continuing to determine. According to this method, not only the realization is simple but also that each array elements in the antenna array can receive arriving signals more reasonably so that the reliability of the antenna array to receive signals is improved.

### FIELD OF THE INVENTION

The present invention relates to an antenna array technology, especially to a method for dynamically selecting antenna array architecture.

### BACKGROUND

In the current Time Division Synchronous Code Division Multiple Access (TD-SCDMA) system, a base station generally uses an antenna array to receive and transmit user signals. The antenna array is composed by multiple antenna units according to a certain distribution mode so as to improve performance of the antenna system in mobile communications. Each antenna unit in the antenna array is an independent unit and each antenna unit is also called an array element and can be an omni-directional antenna or a directional antenna. The distribution of antenna units can be line type, ring type, plane type or three-dimension type. According to the antenna array technology, all the antenna units cooperate to perform receiving and transmission of user signals in different environment. Generally, the base station adopts an 8-array element uniform circular antenna array to receive and detect uplink signals. However, in some cases, for example when the processing ability of the base station is limited, less antenna units, such as 6 array elements or 4 array elements can be used to receive and detect uplink signals so as to guarantee the base station can work properly. When adopted array elements are less than the whole array elements of the antenna array, how to reasonably determine the antenna array architecture is important.

Taking an 8-array element antenna array as an example, when the number of the adopted array elements is less than 8, there are currently two methods to determine a new antenna array architecture. One is to reconstruct a new antenna array according to the currently determined number of array elements; the other is to select the determined number of array elements from the antenna array architecture to form a new array, but not necessarily change former distribution of the antenna array, i.e. not change positions of the selected array elements in the former antenna array. As shown in FIGS. 1a and 1b, FIG. 1a is an 8-array element uniform circular antenna array and FIG. 1b is a new antenna array formed by the selected 6 array elements and reference signs 1-8 in the figures refer to the sequence of the array elements respectively.

The above two methods in determining a new antenna array architecture have their own defects. For the first method, since the former antenna array architecture should be abandoned and totally a new antenna array architecture should be reconstructed, it is difficult in operation and there will be waste in resources and maybe the receiver is not compatible in different cases. Therefore, it is difficult for the first method to be applied in practice.

For the second method, although it is comparatively simple in realization, the ability of the selected array elements to receive arrived signals should be taken into account when selecting array elements so as not to shadow the received signals. Since signal shadowing is associated with arriving angles of signals, while in wireless environment, because of user's moving or obstruction's changing, directions of signals arriving at the array are always in change, the receiver does not know arriving angles of the signals in advance, so if array elements are not properly selected, some signals will be shadowed and can not be received. In other words, if arriving signals are received by a new array formed by existing array elements at fixed positions, there are possibly receiving blind areas, i.e. some areas cannot receive arriving signals, which makes the receiver cannot recover signal sources and cannot work properly. It can be seen the solution with a fixed antenna array architecture is possibly to result in blind areas in receiving signals, i.e. the receiver cannot receive and detect signals at some arriving angles, which makes the communication cannot be performed properly.

### SUMMARY OF THE INVENTION

A main objective of the present invention is to provide a method for dynamically selecting antenna array architecture, which is simple and flexible and can make each array element receive arriving signals more reasonably and which can improve reliability of the antenna array to receive signals.

In order to achieve the above objective, the present invention provides a method for dynamically selecting antenna array architecture, deciding a basic antenna array, determining a number of required array elements, selecting determined number of array elements from all the array elements in the basic antenna array to form an antenna array architecture and receiving and detecting signals with the current antenna array architecture, the method further including:

determining whether transmission time intervals and/or slot positions of received signals change, if so, re-selecting the determined number of array elements from all the array elements in the basic antenna array to form a new antenna array architecture and receiving and detecting signals with the new antenna array architecture, otherwise, continuing to determine.

The basic antenna array is the one of any form. The selecting of determined number of array elements is randomly selecting from all the array elements of the basic antenna array; when the basic antenna array is an 8-array element uniform circular antenna array, the selecting of determined number of array elements from the basic antenna array specifically is randomly selecting 6 array elements or 4 array elements from all the array elements of the 8-array element uniform circular antenna array. The determining of the required number of array elements is determined according to the system processing ability and/or a number of current users.

The method further includes: determining more than one array element combination corresponding to different array elements, and the selecting of determined number of array elements is selecting one array element combination. The re-selecting of the determined number of array elements to form the new antenna array architecture is selecting antenna array architectures formed by different array element combinations or selecting an antenna array architecture formed by a same array element combination, for different slots in a same transmission time interval. Or the re-selecting of the determined number of array elements to form the new antenna array architecture is selecting antenna array architectures formed by different array element combinations or selecting an antenna array architecture formed by a same array element combination, for different slots in different transmission time intervals. Or the re-selecting of the determined number of array elements to form the new antenna array architecture is selecting an antenna array architecture formed by a same array element combination or selecting different antenna array architectures formed by different array element combinations, for a same slot in different transmission time intervals.

According to the method of the present invention for dynamically selecting antenna array architecture, array elements whose number is smaller than that of the whole array elements are selected from the selected basic antenna array architecture to form a new antenna array architecture and when the number of the array elements is comparatively fixed, different array elements are selected for different slots of different transmission time intervals to form different antenna array architectures so that it is simple to realize and has better flexibility and can guarantee the antenna array can receive user signals at different arriving angles, i.e. even the antenna array architecture at some slots shadows a signal at some arriving angle, with the change of slots, each array elements in the antenna array can receive arriving signals more reasonably so as to avoid possible blind area problems of the fixed antenna array architecture, which further improves the performance of the base station system and the reliability of receiving user signals. In addition, in order to avoid the problem that some signals cannot be received for a long time because of shadowing, the method may cooperate with the coding and retransmission mechanisms in the communication system to effectively finish the communication process and provide better services for users.

In the realization process of the present invention, the adopted existing antenna array architecture can be random. For example, the antenna array can be linear antenna array, uniform circular antenna array etc; there may be many choices in determining the number of array elements according to the system processing ability or a number of users, for example, selecting 6 or 5 array elements from the 8-array element antenna array; the selection of array elements can be random, for example, selecting randomly 6 array elements from the 8-array element antenna array; the selection of antenna array architectures corresponding to different transmission slots can be random, for example, selecting the antenna array architecture composed by the first array element to the sixth array element, or the antenna array architecture composed by the third array element to the eighth array element. In addition, the method of the present invention is applicable to all the communication systems receiving signals with an antenna array. The realization of the method of the present invention has strong flexibility, practicability and generality, which can be applicable to a broader range and have multiple forms.

### BRIEF DESCRIPTION OF THE DRAWINGS

FIGS. 1a and 1b are diagrams showing an architecture of an antenna array before and after array elements change according to the prior art;

FIG. 2 is a diagram showing architecture of an 8-array element uniform circular antenna array; and

FIG. 3 is a flow chart showing a realization of a method according to the present invention.

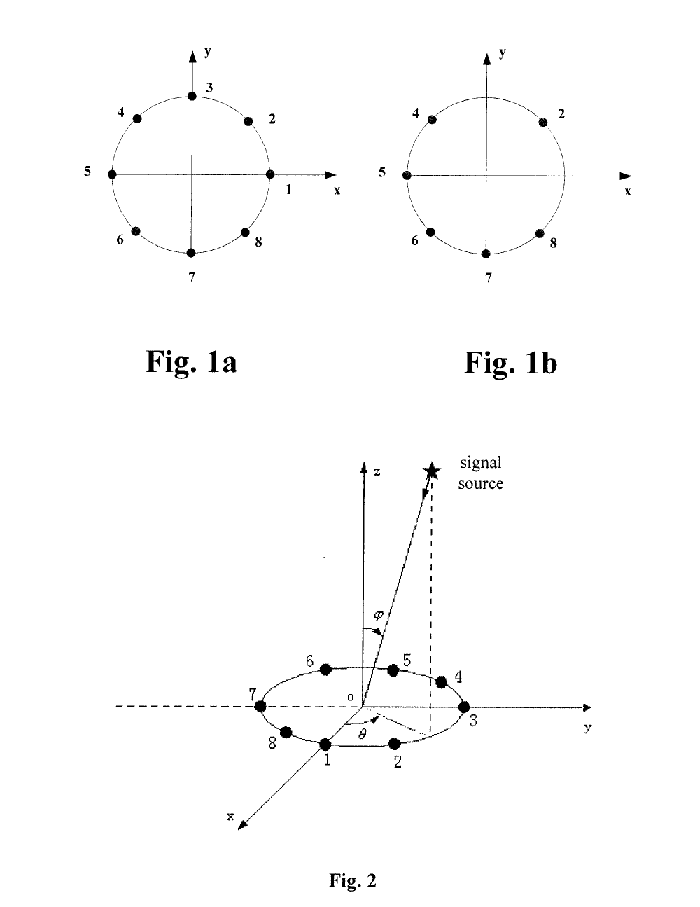

### DETAILED DESCRIPTION OF THE INVENTION

A main idea of the present invention is to select part array elements from all the array elements of the selected basic antenna array to form different antenna array architecture and to dynamically select different antenna array architecture according to changes of slot positions or the transmission time intervals (TTIs) to receive and detect user signals.

The existing antenna array is regarded as the basic antenna array and the existing antenna array refers to a linear antenna array or a circular antenna array of 4 array elements, 8 array elements or 16 array elements etc; the selecting of part array elements is to firstly determine the number of the array elements to be selected according to the system processing ability and/or the number of currently accessed users, then to determine array elements to be selected and it is random to select array elements, for example, if 4 array elements are to be selected from an 8-array element antenna array, 4 continuous array elements can be selected or 4 array elements at a same interval can be selected or 4 array elements at different intervals can be selected etc.; the dynamic selecting of different architectures can be random and the selecting sequence of the possible antenna array architecture is not limited.

The present invention is applicable to any communication system receiving user signals with an antenna array and in the following, only the TD-SCDMA system will be taken as an example. In the present embodiment, the adopted basic antenna array is an 8-array element uniform circular antenna array and 6 array elements are selected to form a new antenna array architecture according to the system processing ability.

FIG. 2 is a diagram showing an architecture of an 8-array element uniform circular antenna array. Reference signs 1˜8 represent from the first array element to the eighth array element. The reference point of the antenna array is the center of the circle and the reference line is a line between the center of the circle and the first array element. The reference signs of the array elements are listed in a counterclockwise sequence. A pentagram in FIG. 2 represents one signal source and the direction of the signal source is represented by (θ, φ), wherein θ represents the azimuth angle of the arriving signal and φ represents the elevation angle of the arriving signal. x, y and z in FIG. 2 represent a three-dimension coordinate axis.

In the present embodiment, there are C₈⁶=28 kinds combinations when selecting 6 array elements from 8 array elements to form a new antenna array architecture. Table 1 shows specific combinations. Signs of array elements in each combination represent the selected array elements. For example, 1, 2, 3, 4, 5, 6 represent that the first array element to the sixth array element are selected; 1, 2, 3, 4, 6, 8 represent the first, second, third, fourth, sixth and eighth array elements are selected.

TABLE 1

| sequence | Array element sign |
|---|---|
| 1 | 1, 2, 3, 4, 5, 6 |
| 2 | 1, 2, 3, 4, 5, 7 |
| 3 | 1, 2, 3, 4, 5, 8 |
| 4 | 1, 2, 3, 4, 6, 7 |
| 5 | 1, 2, 3, 4, 6, 8 |
| 6 | 1, 2, 3, 4, 7, 8 |
| 7 | 1, 2, 3, 5, 6, 7 |
| 8 | 1, 2, 3, 5, 6, 8 |
| 9 | 1, 2, 3, 5, 7, 8 |
| 10 | 1, 2, 3, 6, 7, 8 |
| 11 | 1, 2, 4, 5, 6, 7 |
| 12 | 1, 2, 4, 5, 6, 8 |
| 13 | 1, 2, 4, 5, 7, 8 |
| 14 | 1, 2, 4, 6, 7, 8 |
| 15 | 1, 2, 5, 6, 7, 8 |
| 16 | 1, 3, 4, 5, 6, 7 |
| 17 | 1, 3, 4, 5, 6, 8 |
| 18 | 1, 3, 4, 5, 7, 8 |
| 19 | 1, 3, 4, 6, 7, 8 |
| 20 | 1, 3, 5, 6, 7, 8 |
| 21 | 1, 4, 5, 6, 7, 8 |
| 22 | 2, 3, 4, 5, 6, 7 |
| 23 | 2, 3, 4, 5, 6, 8 |
| 24 | 2, 3, 4, 5, 7, 8 |
| 25 | 2, 3, 4, 6, 7, 8 |
| 26 | 2, 3, 5, 6, 7, 8 |
| 27 | 2, 4, 5, 6, 7, 8 |
| 28 | 3, 4, 5, 6, 7, 8 |

Similarly, if n array elements are selected from m array elements to form a new antenna array architecture, there are Cₘⁿ kinds combinations. In practice, different array elements may be selected each time to form a new antenna array architecture, or an array element combination table such as Table 1 may be created in advance and one sequence is selected each time so as to further get the corresponding array element combination and then to form a new antenna array architecture by the selected array element combination.

In the present invention, there are many choices in dynamically selecting different antenna array architectures according to changes of slots or TTIs. For example, one selected array element combination is adopted for each slot of each TTI or the same array element combination is adopted for the same sub-frame or frame of each TTI. The antenna array architectures for different slots of the same TTI can be the same or different; the antenna array architectures for different slots of different TTIs can be the same or different.

Specifically, when the TTI is 20 ms, each TTI includes two frames, each frame is composed by two sub-frames and each sub-frame has multiple slots. Generally, when the service traffic is low, a service only occupies one slot of each sub-frame and when the service traffic is high, a service may occupy multiple slots of one sub-frame.

Taking a 12.2 kbps service as an example, this service only occupies one slot of each sub-frame, which means each TTI includes four slots associated with this service. Then in specific operation, four combinations can be selected in the same TTI. For example, the 3^{rd}, 7^{th}, 19^{th} and 27^{th} combinations in Table 1 are selected and each sub-frame or slot adopts one combination. That is, in the same TTI, one slot associated with the service of the first sub-frame adopts the 3^{rd} array element combination, one slot associated with the service of the second sub-frame adopts the 7^{th} array element combination, one slot associated with the service of the third sub-frame adopts the 19^{th} array element combination and one slot associated with the service of the fourth sub-frame adopts the 27^{th} array element combination. Or two combinations can be selected in the same TTI with the same frame adopting the same array element combination. For example, the 3^{rd}, 7^{th} combinations in Table 1 are selected, in the same TTI, one slot associated with the service of the first sub-frame and one slot associated with the service of the second sub-frame adopt the 3^{rd} array element combination, one slot associated with the service of the third sub-frame and one slot associated with the service of the fourth sub-frame adopt the 7^{th} array element combination.

For different TTIs such as for the two TTIs which include 8 sub-frames for the 12.2 kbps service, eight array element combinations can be selected and each sub-frame uses one array element combination; or four array element combinations can be selected and the same sub-frame or slot in the two TTIs can use the same array element combination, for example, in each TTI, one slot associated with the service of the first sub-frame adopts the 3^{rd} array element combination, one slot associated with the service of the second sub-frame adopts the 7^{th} array element combination, one slot associated with the service of the third sub-frame adopts the 19^{th} array element combination and one slot associated with the service of the fourth sub-frame adopts the 27^{th} array element combination; of course the same array element combination may be used for the same frame of the two TTIs. The processing for TTIs more than two is the same as the above.

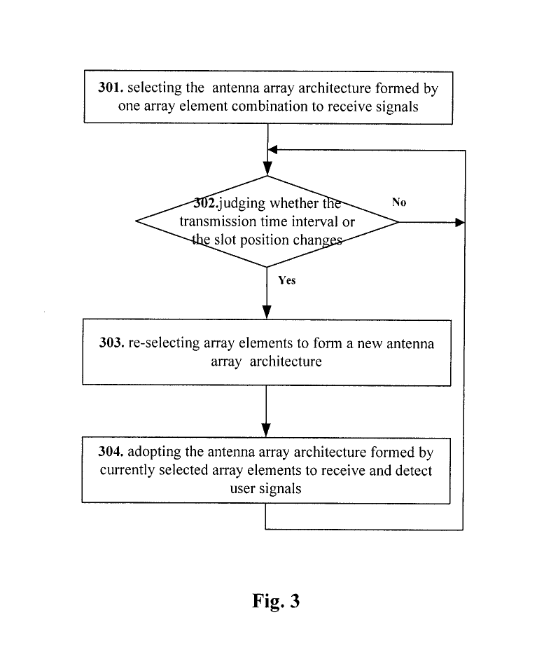

When the method of the present invention is used to receive uplink signals, the processing flow is specifically shown in FIG. 3. The precondition of the method is that the basic antenna array is decided and the number of the array elements used to receive user signals is determined according to the system processing ability and the possible array element combinations are further determined. The method includes the following steps.

In step 301, one array element combination is selected randomly and the receiver of the base station receives user signals with the antenna array architecture formed by the selected array elements.

In step 302˜303, the receiver judges whether the TTI or the slot position changes, if so, re-select an array element combination to form a new antenna array architecture; otherwise, return to step 302.

Since in the standards, TTIs corresponding to different services are specified so that high layer may determine a dividing point of the TTIs according to the service type of the user and the system clock and notify the receiver about the TTI so that the receiver may determine whether the TTI changes. Further, the slot position in each TTI is determined by the system frame structure and the receiver determines whether the slot position changes according to the change of the system clock.

If the TTI or the slot position changes, a new array element combination should be selected. The process of reselecting an array element combination specifically includes the receiver selects any possible array element combination in each slot of each TTI according to different TTIs. For different slots of the same TTI, the antenna array architectures may be the same or different; for different slots of different TTIs, the antenna array architectures may be the same or different; for the same slot of different TTIs, the antenna array architectures may be the same or different.

In step 304, the receiver receives and detects the arriving user signals with the new antenna array architecture formed by the array elements selected in step 302, and then the process returns to step 302.

The processing in step 304 shows that the antenna array architecture formed by newly selected array elements is adopted for each slot to receive and detect signals in the corresponding slot, the processing on signal of the antenna array for each slot is independent and the selected array elements for each slot may be the same or different.

The method for dynamically selecting antenna array architecture of the present invention is applicable to any communication system receiving user signals with an antenna array. As long as the number of the array elements participating the receiving or processing is smaller than that of the array elements of the basic antenna array, the receiver can select any possible number of array elements from the basic antenna array randomly to receive and detect user signals at different time.

The above are only preferred embodiments of the present invention and is not intended to limit the protection scope of the present invention.

1. A method for dynamically selecting antenna array architecture, deciding a basic antenna array, determining a number of required array elements, selecting determined number of array elements from all the array elements in the basic antenna array to form an antenna array architecture and receiving and detecting signals with the current antenna array architecture, the method further comprising:
determining whether transmission time intervals and/or slot positions of received signals change, if so, re-selecting the determined number of array elements from all the array elements in the basic antenna array to form a new antenna array architecture and receiving and detecting signals with the new antenna array architecture, otherwise, continuing to determine.

2. According to the method of claim 1, wherein the basic antenna array is the one of any form.

3. According to the method of claim 1, wherein the selecting of determined number of array elements is randomly selecting from all the array elements of the basic antenna array.

4. According to the method of claim 1, wherein the determining of the required number of array elements is determined according to the system processing ability and/or a number of current users.

5. According to the method of claim 2, wherein the basic antenna array is an 8-array element uniform circular antenna array.

6. According to the method of claim 5, wherein the selecting of determined number of array elements from the basic antenna array specifically is randomly selecting 6 array elements or 4 array elements from all the array elements of the 8-array element uniform circular antenna array.

7. According to the method of claim 1, wherein the method further includes: determining more than one array element combination corresponding to different array elements, and the selecting of determined number of array elements is selecting one array element combination.

8. According to the method of claim 7, wherein the re-selecting of the determined number of array elements to form the new antenna array architecture is selecting antenna array architectures formed by different array element combinations or selecting an antenna array architecture formed by a same array element combination, for different slots in a same transmission time interval.

9. According to the method of claim 7, wherein the re-selecting of the determined number of array elements to form the new antenna array architecture is selecting antenna array architectures formed by different array element combinations or selecting an antenna array architecture formed by a same array element combination, for different slots in different transmission time intervals.

10. According to the method of claim 7, wherein the re-selecting of the determined number of array elements to form the new antenna array architecture is selecting an antenna array architecture formed by a same array element combination or selecting different antenna array architectures formed by different array element combinations, for a same slot in different transmission time intervals.

11. According to the method of claim 3, wherein the basic antenna array is an 8-array element uniform circular antenna array.

12. According to the method of claim 11, wherein the selecting of determined number of array elements from the basic antenna array specifically is randomly selecting 6 array elements or 4 array elements from all the array elements of the 8-array element uniform circular antenna array.

13. According to the method of claim 2, wherein the method further includes: determining more than one array element combination corresponding to different array elements, and the selecting of determined number of array elements is selecting one array element combination.

14. According to the method of claim 3, wherein the method further includes: determining more than one array element combination corresponding to different array elements, and the selecting of determined number of array elements is selecting one array element combination.

15. According to the method of claim 13, wherein the re-selecting of the determined number of array elements to form the new antenna array architecture is selecting antenna array architectures formed by different array element combinations or selecting an antenna array architecture formed by a same array element combination, for different slots in a same transmission time interval.

16. According to the method of claim 14, wherein the re-selecting of the determined number of array elements to form the new antenna array architecture is selecting antenna array architectures formed by different array element combinations or selecting an antenna array architecture formed by a same array element combination, for different slots in a same transmission time interval.

17. According to the method of claim 13, wherein the re-selecting of the determined number of array elements to form the new antenna array architecture is selecting antenna array architectures formed by different array element combinations or selecting an antenna array architecture formed by a same array element combination, for different slots in different transmission time intervals.

18. According to the method of claim 14, wherein the re-selecting of the determined number of array elements to form the new antenna array architecture is selecting antenna array architectures formed by different array element combinations or selecting an antenna array architecture formed by a same array element combination, for different slots in different transmission time intervals.

19. According to the method of claim 13, wherein the re-selecting of the determined number of array elements to form the new antenna array architecture is selecting an antenna array architecture formed by a same array element combination or selecting different antenna array architectures formed by different array element combinations, for a same slot in different transmission time intervals.

20. According to the method of claim 14, wherein the re-selecting of the determined number of array elements to form the new antenna array architecture is selecting an antenna array architecture formed by a same array element combination or selecting different antenna array architectures formed by different array element combinations, for a same slot in different transmission time intervals.
